(19) United States
(12) Patent Application Publication
(10) Pub. No.: US 2017/0099334 A1
(43) Pub. Date: Apr. 6, 2017

(54) MULTIMEDIA CONTEST SYSTEM

(71) Applicant: C-WIN TECHNOLOGIES, LLC, Scarsdale, NY (US)

(72) Inventors: James Zalcman, Boston, MA (US); Edward Ovando, Endicott, NY (US); Clay Himmelberger, Endicott, NY (US)

(21) Appl. No.: 15/287,327

(22) Filed: Oct. 6, 2016

Related U.S. Application Data
(60) Provisional application No. 62/237,972, filed on Oct. 6, 2015.

(51) Int. Cl. H04L 29/06; G06Q 50/34; H04L 29/08

(52) U.S. Cl. CPC H04L 65/60; H04L 65/608; H04L 65/403; H04L 65/1069; H04L 67/104; G06Q 50/34; H04L 67/02

(57) ABSTRACT

A multimedia contest system includes a server and a plurality of electronic devices configured to execute instructions stored in the server and/or the plurality of electronic devices to implement a multimedia contest between participants operating the plurality of electronic devices. Implementing the multimedia contest includes establishing network communication between the plurality of electronic devices, capturing media streams at each of the plurality of electronic devices, communicating the media streams of each of the plurality of electronic devices to others of the plurality of electronic devices, displaying the media streams of each of the plurality of electronic devices simultaneously on at least one display; and sequentially removing at least one of the media streams from the at least one display until only one of the media streams is displayed on the at least one display.

### CROSS-REFERENCE TO RELATED APPLICATION(S)

This application claims the benefit of U.S. Provisional Application No. 62/237,972 filed Oct. 6, 2015 for “Multimedia Contest System” by J. Zalcman, E. Ovando and C. Himmelberger.

### INCORPORATION BY REFERENCE

The above-mentioned U.S. Provisional Application No. 62/237,972 is hereby incorporated by reference in its entirety.

### BACKGROUND

The present invention relates to a multimedia contest system.

### SUMMARY

A multimedia contest system includes a server and a plurality of electronic devices configured to execute instructions stored in the server and/or the plurality of electronic devices to implement a multimedia contest between participants operating the plurality of electronic devices. Implementing the multimedia contest includes establishing network communication between the plurality of electronic devices, capturing media streams at each of the plurality of electronic devices, communicating the media streams of each of the plurality of electronic devices to others of the plurality of electronic devices, displaying the media streams of each of the plurality of electronic devices simultaneously on at least one display; and sequentially removing at least one of the media streams from the at least one display until only one of the media streams is displayed on the at least one display.

### BRIEF DESCRIPTION OF THE DRAWINGS

FIG. 1A is a diagram illustrating a first embodiment of a multimedia contest system configured to communicate participants' devices media streams via peer-to-peer communication.

FIG. 1B illustrates the establishment of peer-to-peer connections in the multimedia contest system of FIG. 1A according to an exemplary embodiment.

FIG. 2 is a diagram illustrating a second of a multimedia contest system configured to communicate participants' devices media streams via server-managed communication.

FIG. 3 is a screenshot of an initial round of a multimedia contest, which includes media streams from six participants displayed on the screen of each device.

FIG. 4 is a screenshot illustrating a subsequent round of a multimedia contest, in which one participant's media stream is removed from the display, so that only five media streams are shown on the screen of each device, corresponding to five participants that are still active in the contest.

FIGS. 5A and 5B are diagrams illustrating the game flow of a multimedia contest system according to an embodiment of the invention, from the perspective of a participant's device.

FIG. 6 illustrates screenshots of various stages of a multimedia contest in an internet based social gaming system that uses cloud based infrastructures to serve up the multimedia contest and manage the connection of users globally.

FIG. 7 is a diagram of another modified embodiment of a multimedia contest system in a live event sweepstakes system that creates a single public view of the knockout game with multiple users trying to connect from their mobile devices to participate on a Jumbotron (or similarly large display device).

### DETAILED DESCRIPTION

Disclosed herein is a multimedia contest system, which may be a game entitled “Selfie Surprise” in some embodiments. The system allows a plurality of players to have a live streaming experience during sweepstakes, giveaways, lotteries, social casino and/or real money gaming contests on computers and/or mobile devices. The system allows a plurality of players to participate in a contest, which in some embodiments is entirely chance-based, involving a shared media stream and selectively communicated media between the players.

In one exemplary embodiment, a plurality of players, such as six in one example, join and participate in a game that involves a live media stream from each player being transmitted onto the active game screen of each player's device, so that each player is able to view all of the media streams. In other embodiments, in order to reduce bandwidth that is used, each player's media stream may be one or a series of photographs instead of a live media stream. Then, one player's media stream (or a group of players' media streams) is eliminated from the active game screen, after a time interval that may be predetermined or random, and may be anywhere from a few seconds to 15-30 seconds, or even longer in some embodiments. This pattern is repeated, with the players' media streams being eliminated from the active game screen one by one, or in groups, until only a single player's media stream is shown on the active game screen. In an exemplary embodiment, all players then are able to view the media stream of the last remaining player (the winner), which may show that player celebrating victory in the game.

In an exemplary embodiment, each user may initiate a financial transaction in order to participate in the game, which may be in the form of an automatic account debit, a manual payment or payment authorization, or any other form of initiating a payment or financial transaction. In some embodiments, the winner of the game may receive a financial reward via an automatic or manual financial transaction, or may receive some other reward and/or recognition.

The technology implementing the multimedia contest system integrates multiple servers, clients, animation and a live video stream and then ultimately marries them to a random number generator that determines the winners of the game. The system may also be configured to coordinate multiple media stream speeds so that the players all have the same real-time experience regardless of connection or device.

The system described above may, in an exemplary embodiment, be built on a multimedia sharing application that follows the Web Real-Time Communication (WebRTC) standard that enables real-time peer-to-peer communication between devices and/or between devices and servers. The WebRTC application is operable to perform several tasks, including acquiring streaming audio, video or other data; acquiring network information such as IP addresses and ports, and exchanging this information with other WebRTC clients (i.e., peers) to enable connection; coordinating signaling communication to report errors and initiate or close sessions; exchanging information about media and client capability; and communicating streaming audio, video or data between devices.

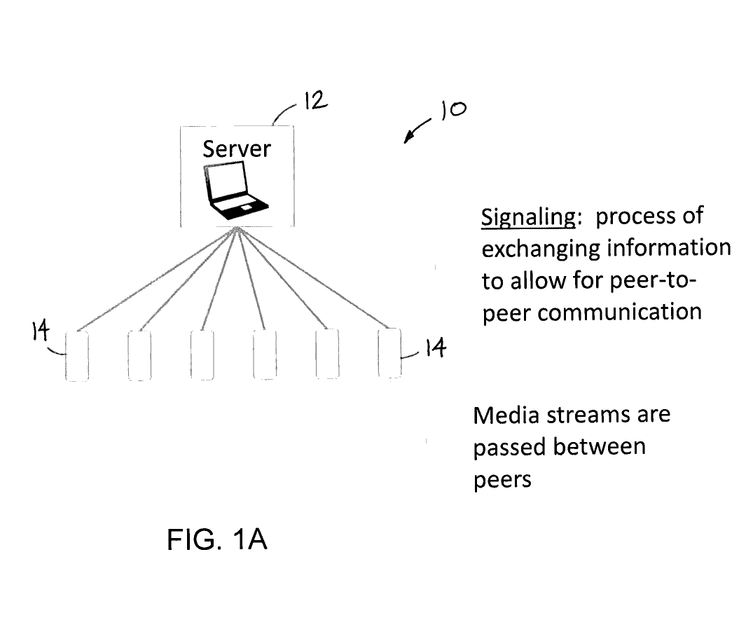

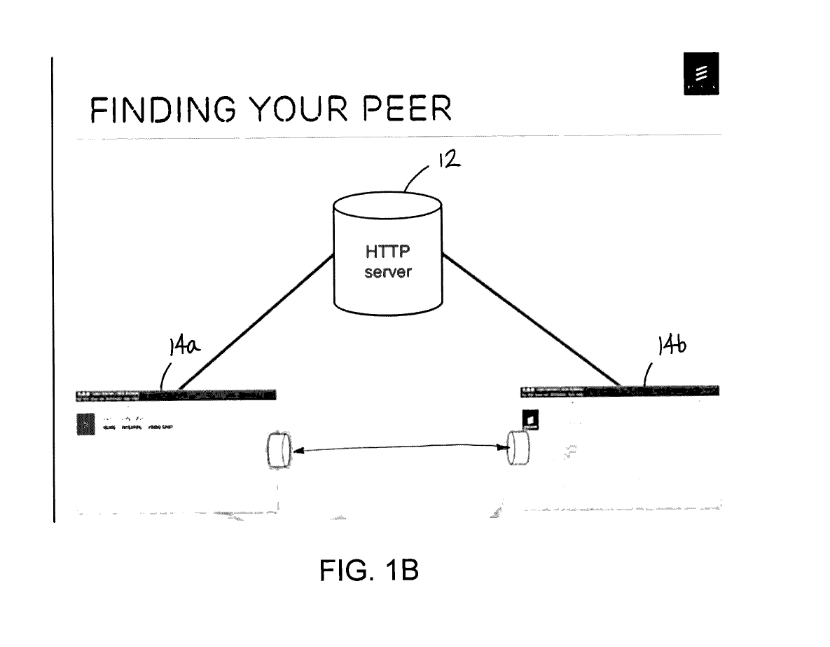

The WebRTC application may allow devices to communicate with each other in a number of different configurations and roles. FIG. 1A is a diagram illustrating a first embodiment in which system 10 is configured to communicate participants' devices media streams via peer-to-peer communication. In this embodiment, server 12 exchanges information in two-way communication with devices 14, such as session description information and network data, for example, in order to create a network environment in which peer-to-peer communication between devices 14 may be performed. The media streams of each of devices 14 are communicated between the devices 14 themselves in this embodiment, without being relayed through server 12.

In order for the peer-to-peer communication shown in FIG. 1A to be established, the peer-to-peer connections must be initialized and established. FIG. 1B illustrates the establishment of peer-to-peer connections according to an exemplary embodiment. As shown in FIG. 1B, server 12 (an HTTP server in the example shown) communicates with devices 14a and 14b to provide control signaling and other information relating to the peer-to-peer communication protocol that will be established. Although an HTTP server is illustrated for server 12 in FIG. 1B, other types of servers and communication protocols may be used in certain embodiments, such as WebSocket or other protocols. Once the information needed for the peer-to-peer communication link to be established between devices 14a and 14b has been communicated, the devices may communicate media streams and other data with one another using a selected protocol such as User Diagram Protocol (UDP), Real-Time Transport Protocol (RTP), Stream Control Transmission Protocol (SCTP), or others.

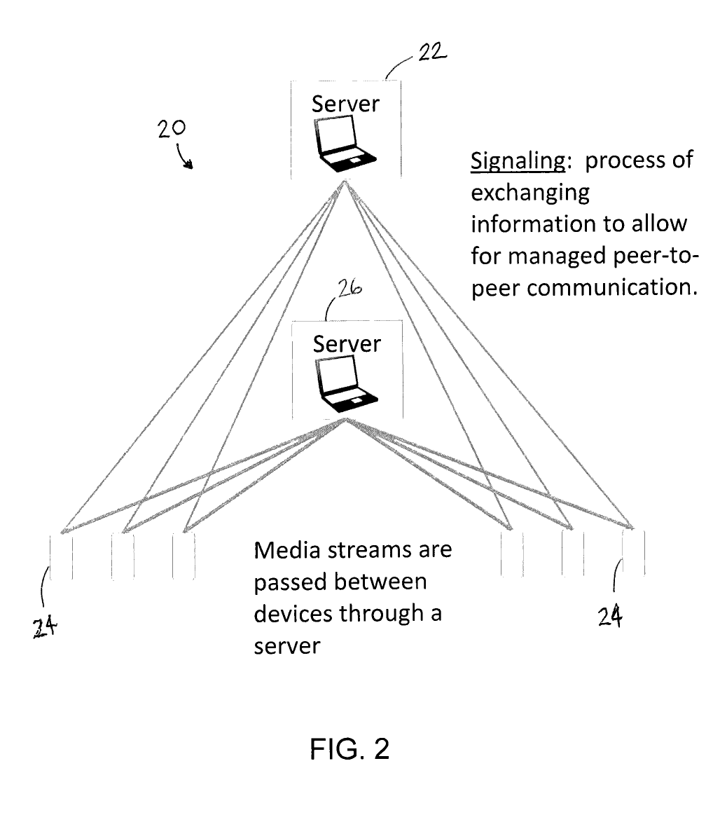

FIG. 2 is a diagram illustrating a second embodiment in which system 20 is configured to communicate participants' devices media streams via server-managed communication. In this embodiment, system server 22 exchanges information in two-way communication with devices 24, such as session description information, network data, and information about device server 26, for example, in order to create a network environment in which communication between devices 24 may be achieved via device server 26. The media streams of each of devices 24 are communicated between the devices 24 by relaying the streams and/or information related to the streams through device server 26, which is configured to broadcast the streams and/or information related to the streams to devices 24 over a network communication channel

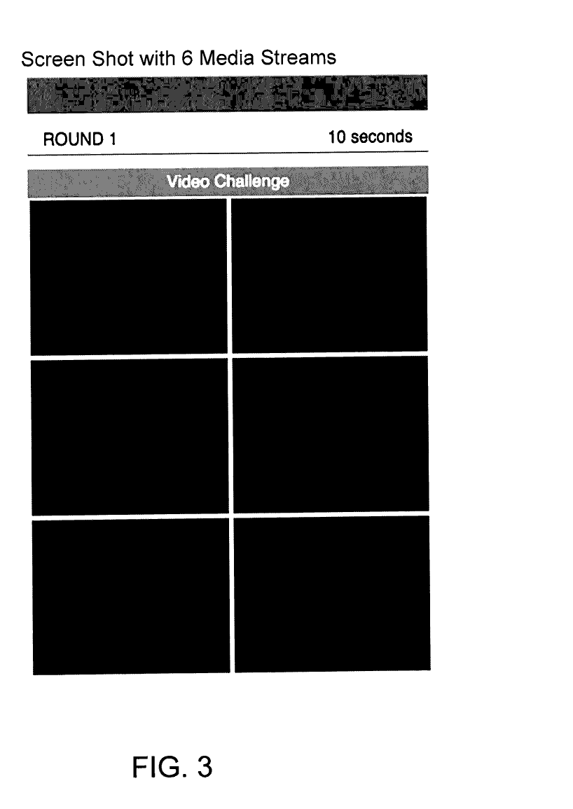

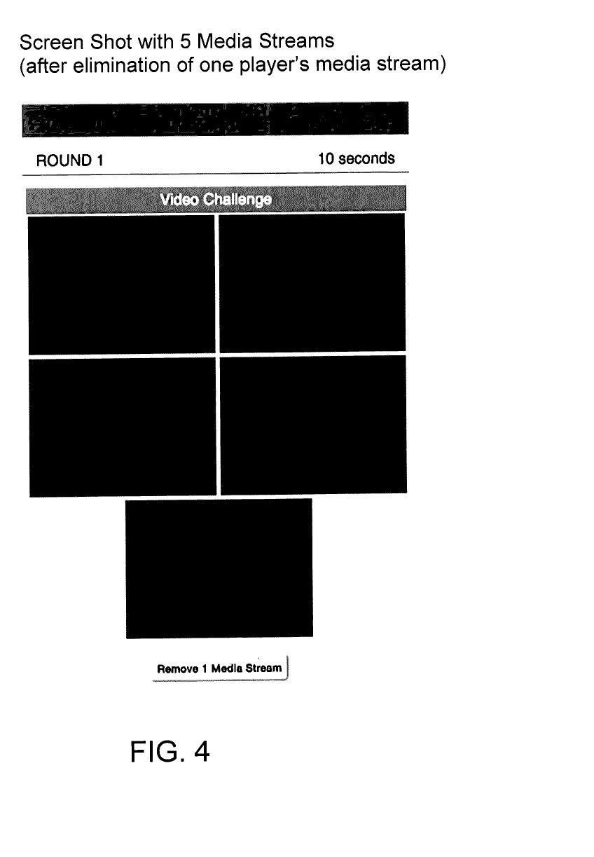

FIGS. 3 and 4 illustrate an exemplary design of the multimedia contest system application for execution on participants' devices. FIG. 3 is a screenshot of an initial round of the multimedia contest, which includes media streams from six participants displayed on the screen of each device. The media streams are shown in FIG. 3 as black screen areas, for simplicity of illustration, but it should be understood that in many embodiments, each box shown in FIG. 3 would be a live media stream or an image or sequence of images from each participant. For example, a live video stream of each participant may be displayed in each box shown in FIG. 3, to signify that the participant is still active in the contest. Then, as shown in the screenshot illustration of FIG. 4, one participant's media stream is removed from the display, so that only five media streams are shown on the screen of each device, corresponding to five participants that are still active in the contest. This process will then continue until only a single participant remains, who is the winner of the contest.

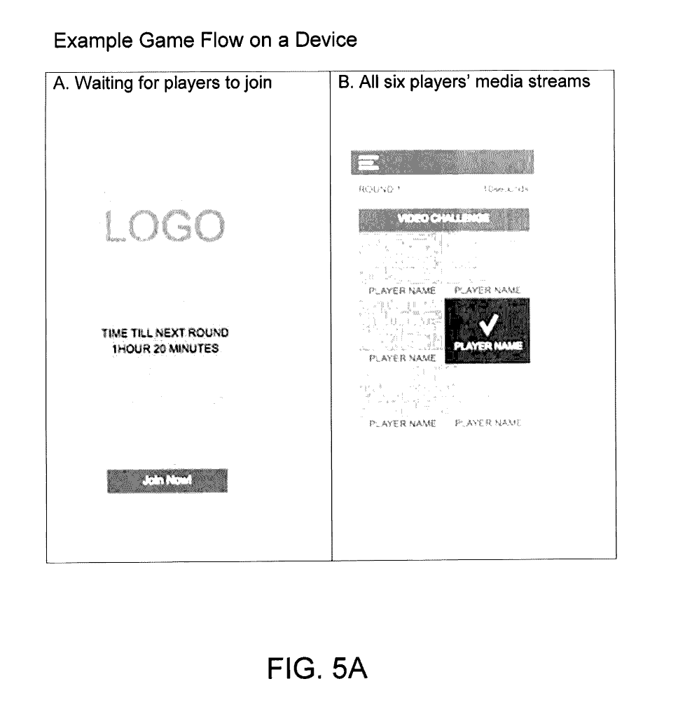

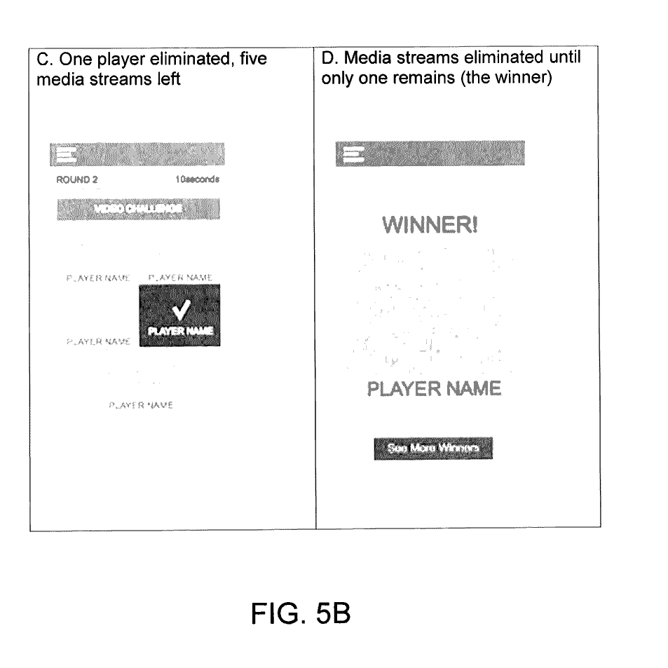

FIGS. 5A and 5B are diagrams illustrating the game flow of the multimedia contest system according to an embodiment of the invention, from the perspective of a participant's device. In FIG. 5A, box A shows an initial stage of the system application, before a contest has begun. This screen indicates the time until the next contest is scheduled to begin, and allows a participant to join the contest by making a selection on the screen. Box B in FIG. 5A shows a stage of the system application where the contest has begun, with six participants' media streams being shown on the screen, along with the names of the participants. Box C in FIG. 5B shows a subsequent stage of the system application, where one participant's media stream has been eliminated, leaving five participants' media streams being shown on the screen. The participants are eliminated one by one in this example, until only one participant is left (the winner of the contest), which is shown in Box D in FIG. 5B.

In some embodiments, additional functionality or features may be provided for the players while waiting for the next elimination to occur, such as a chat feature, a voting feature, or others.

The concept of the multimedia contest “knockout game” described above has been expanded to other working prototypes, that allow the concept to be cross-functional across many different platforms and marketplaces. In each prototype the multimedia contest (or “knockout game”) software controls the graphical animations and user experience. The software also controls the camera and microphone on mobile and compatible camera-enabled hardware devices.

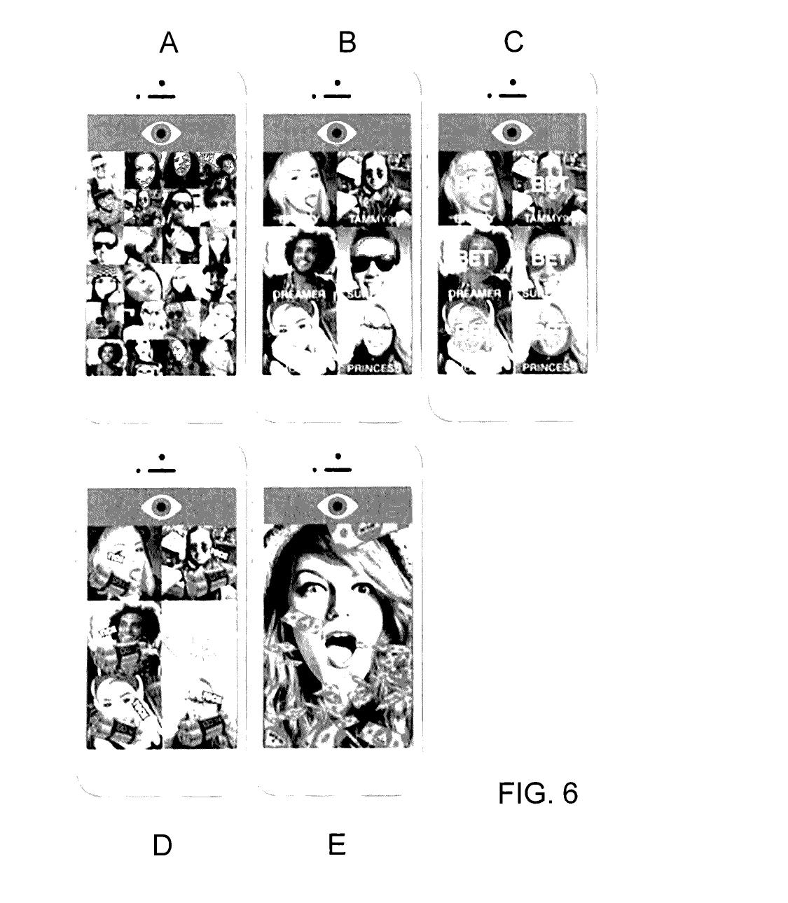

One example of a modified multimedia contest system is an internet based social gaming system that uses cloud based infrastructures to serve up the multimedia contest and manage the connection of users globally. Each user can view the entire social game on their device, and various stages of the game are shown on device screenshots illustrated in FIG. 6 as screenshots A, B, C, D and E. Similar to the description of the game flow in FIGS. 5A and 5B above, when the multimedia contest system reaches enough players, the knockout game begins, and participants are eliminated until a winner is selected. Screenshot A in FIG. 6 shows media streams or other identifiers of various users of the social gaming system, which may be selected or otherwise reduced to the six game participants shown in screenshot B. In some embodiments, wagering of real life or virtual currency may be made on a selection of a predicted winner of the contest, as shown in screenshot C. A participant is then eliminated, as shown in screenshot D, until only one participant remains, who is identified as the winner, as shown in screenshot E. Leaderboards, point systems, and other game mechanics may be configured to create a more detailed interactive game experience.

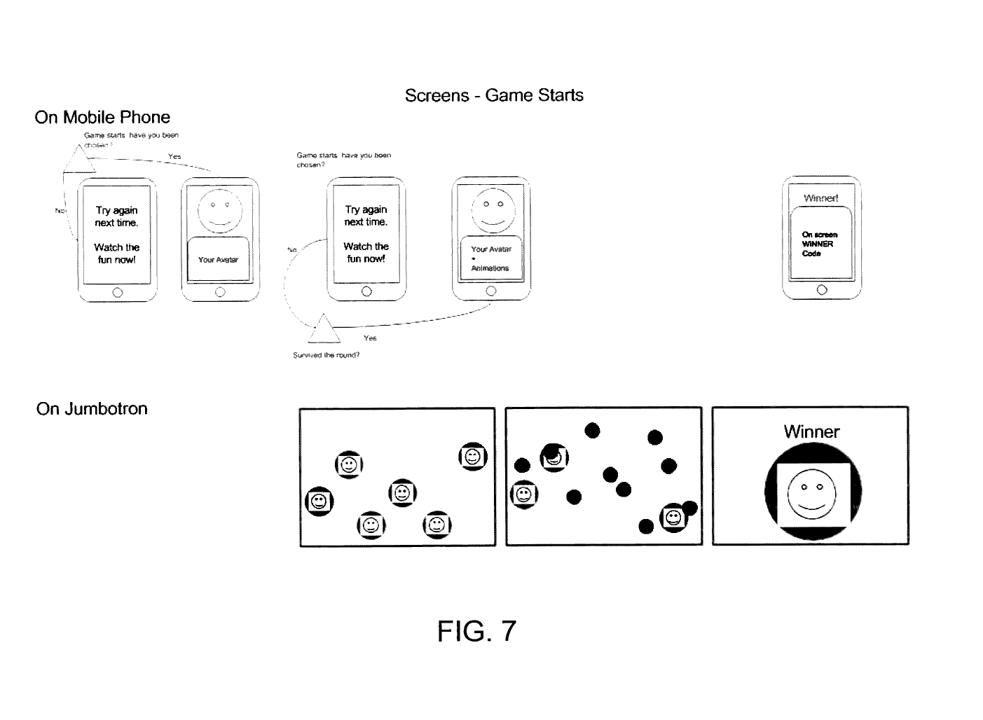

Another modified embodiment of the multimedia contest system is a live event sweepstakes system that creates a single public view of the knockout game with multiple users trying to connect from their mobile devices to participate on a Jumbotron (or similarly large display device), as illustrated in FIG. 7. A limited number of on-screen participants are chosen from the pool of user requests. Participants chosen will have their live-stream broadcast displayed on a single public screen, and participants are eliminated in a similar manner to the “knockout game” game flow described above until a winner is chosen. In some embodiments, the winner is then awarded a sweepstakes prize, and will receive notification of their game win and of the awarding of the sweepstakes prize via their device.

In the embodiments described above, servers and electronic devices are described with processing and communication capabilities, and these devices include one or more storage media, input/output interfaces, and processors. In some examples, the devices may include more or fewer components. The processors of the servers and electronic devices, in one example, are configured to implement functionality and/or process instructions for execution by the device housing the processor. For instance, a processor can be capable of processing instructions stored in storage media. Examples of processors can include any one or more of a microprocessor, a controller, a digital signal processor (DSP), an application specific integrated circuit (ASIC), a field-programmable gate array (FPGA), or other equivalent discrete or integrated logic circuitry.

The processors of the server and/or electronic devices interface with other functional components of the devices, including the camera and a display screen of the electronic devices, for example. In some embodiments, the processor of each electronic device may control the camera of the electronic device to capture a media stream, such as full motion video in some embodiments, for transmission to other electronic devices to participate in the multimedia contest described above.

Storage media can be configured to store information within a server and electronic devices during operation. Storage media, in some examples, are described as computer-readable storage media. In some examples, a computer-readable storage media can include non-transitory media. The term “non-transitory” can indicate that the storage media is not embodied in a carrier wave or a propagated signal. In certain examples, a non-transitory storage medium can store data that can, over time, change (e.g., in RAM or cache). In some examples, the storage media is a temporary memory, meaning that a primary purpose of storage device(s) 64 is not long-term storage. Storage media, in some examples, is described as volatile memory, meaning that the storage media does not maintain stored contents when power is turned off. Examples of volatile memories can include random access memories (RAM), dynamic random access memories (DRAM), static random access memories (SRAM), and other forms of volatile memories. In some examples, storage media is used to store program instructions for execution by processors. Storage media, in one example, is used by software or applications running on a server and a plurality of electronic devices to temporarily store information during program execution.

In some embodiments, storage media can be configured to store larger amounts of information than volatile memory. Storage media can further be configured for long-term storage of information. In some examples, storage media includes non-volatile storage elements. Examples of such non-volatile storage elements can include magnetic hard discs, optical discs, flash memories, or forms of electrically programmable memories (EPROM) or electrically erasable and programmable (EEPROM) memories. Storage media can include program segments, pulse detector segments, pattern sequence recognition segments, and image processing segments, etc.

The server and electronic devices also include input/output interfaces. In some embodiments, the input/output interfaces can utilize communications modules to communicate with external devices via one or more networks, such as one or more wireless or wired networks or both. The input/output interfaces can be a network interface card, such as an Ethernet card, an optical transceiver, a radio frequency transceiver, or any other type of device that can send and receive information. Other examples of such network interfaces can include Bluetooth, 3G, 4G, and WiFi radio computing devices, as well as Universal Serial Bus (USB).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A multimedia contest system, comprising:
a server having at least one server processor, at least one server input/output interface and at least one server storage medium;
a plurality of electronic devices communicatively coupled to the server, each of the plurality of electronic devices having at least one device processor, at least one device input/output interface and at least one device storage medium;
wherein the server and each of the plurality of electronic devices are configured to execute instructions stored in the at least one server storage medium and the at least one device storage medium to implement a multimedia contest between participants operating the plurality of electronic devices, including:
establishing network communication between the plurality of electronic devices;
capturing media streams at each of the plurality of electronic devices;
communicating the media streams of each of the plurality of electronic devices to others of the plurality of electronic devices;
displaying the media streams of each of the plurality of electronic devices simultaneously on at least one display; and
sequentially removing at least one of the media streams from the at least one display until only one of the media streams is displayed on the at least one display.

2. The multimedia contest system of claim 1, wherein sequentially removing at least one of the media streams from the at least one display comprises randomly selecting a media stream to be removed, and communicating information identifying the media stream to be removed from the server to the plurality of electronic devices.

3. The multimedia contest system of claim 1, wherein establishing network communication between the plurality of electronic devices comprises communicating session description information and network data between the server and the plurality of electronic devices.

4. The multimedia contest system of claim 1, wherein communicating the media streams of each of the plurality of electronic devices to others of the plurality of electronic devices comprises peer-to-peer communication of the media streams between the plurality of electronic devices.

5. The multimedia contest system of claim 1, wherein the multimedia contest system further comprises a device server communicatively coupled to the plurality of electronic devices, and communicating the media streams of each of the plurality of electronic devices to others of the plurality of electronic devices comprises transmitting the media streams to the device server and broadcasting the media streams from the device server to the plurality of electronic devices.

6. The multimedia contest system of claim 1, wherein capturing the media streams at each of the plurality of electronic devices comprises operating a camera of each of the plurality of electronic devices to record video of the participant operating the electronic device.

7. The multimedia contest system of claim 1, wherein the at least one display comprises display screens of the plurality of electronic devices.

8. The multimedia contest system of claim 1, wherein the at least one display comprises a common display viewable by the participants.

9. The multimedia contest system of claim 1, wherein the server and each of the plurality of electronic devices are further configured to execute instructions stored in the at least one server storage medium and the at least one device storage medium to allow the participants to initiate a financial transaction to participate in the multimedia contest.

10. The multimedia contest system of claim 1, wherein the server and each of the plurality of electronic devices are further configured to execute instructions stored in the at least one server storage medium and the at least one device storage medium to allow the participants to place financial wagers on an outcome of the multimedia contest.

11. A method of conducting a multimedia contest between a plurality of participants operating a plurality of electronic devices, comprising:
communicating network information and data between a server and the plurality of electronic devices to establish network communication between the plurality of electronic devices;
capturing media streams at each of the plurality of electronic devices;
communicating the media streams of each of the plurality of electronic devices to others of the plurality of electronic devices;
displaying the media streams of each of the plurality of electronic devices simultaneously on at least one display; and
sequentially removing at least one of the media streams from the at least one display until only one of the media streams is displayed on the at least one display.

12. The method of claim 11, wherein sequentially removing at least one of the media streams from the at least one display comprises randomly selecting a media stream to be removed, and communicating information identifying the media stream to be removed from the server to the plurality of electronic devices.

13. The method of claim 11, wherein establishing network communication between the plurality of electronic devices comprises communicating session description information and network data between the server and the plurality of electronic devices.

14. The method of claim 11, wherein communicating the media streams of each of the plurality of electronic devices to others of the plurality of electronic devices comprises peer-to-peer communication of the media streams between the plurality of electronic devices.

15. The method of claim 11, wherein communicating the media streams of each of the plurality of electronic devices to others of the plurality of electronic devices comprises transmitting the media streams to a device server and broadcasting the media streams from the device server to the plurality of electronic devices.

16. The method of claim 11, wherein capturing the media streams at each of the plurality of electronic devices comprises operating a camera of each of the plurality of electronic devices to record video of the participant operating the electronic device.

17. The method of claim 11, wherein the at least one display comprises display screens of the plurality of electronic devices.

18. The method of claim 11, wherein the at least one display comprises a common display viewable by the participants.

19. The method of claim 11, further comprising allowing the participants to initiate a financial transaction to participate in the multimedia contest.

20. The method of claim 11, further comprising allowing the participants to place financial wagers on an outcome of the multimedia contest.
